(19) United States
(12) Patent Application Publication
(10) Pub. No.: US 2025/0262724 A1
(43) Pub. Date: Aug. 21, 2025

(54) Wrench Device

(71) Applicant: Andrew Brand, Niceville, FL (US)

(72) Inventor: Andrew Brand, Niceville, FL (US)

(21) Appl. No.: 18/747,603

(22) Filed: Jun. 19, 2024

Related U.S. Application Data
(60) Provisional application No. 63/555,419, filed on Feb. 20, 2024.

(51) Int. Cl. B25B 13/56; B25B 13/04; B25B 13/08; B25B 13/46

(52) U.S. Cl. CPC B25B 13/56; B25B 13/04; B25B 13/08; B25B 13/462

(57) ABSTRACT

A wrench device is disclosed that is a combination, handheld wrench, or set of wrenches. The wrench device comprises a handle component with a head component secured to each end. The wrench device will have an SAE size on one head component and an equivalent metric size, on the other head component. Further, the wrench device is available in numerous equivalent sizes and configurations for all applications. Accordingly, the wrench device will benefit the user by having both SAE and metric sizes on a single wrench. This contributes to the user's timely completion of the project without having to return to the toolbox or job site to acquire the correct sized wrench.

### CROSS-REFERENCE TO RELATED APPLICATION

The present application claims priority to, and the benefit of, U.S. Provisional Application No. 63/555,419, which was filed on Feb. 20, 2024, and is incorporated herein by reference in its entirety.

### FIELD OF THE INVENTION

The present invention relates generally to the field of wrench devices. More specifically, the present invention relates to a wrench or set of wrenches featuring the equivalent Society of Automotive Engineers (SAE) and metric sizes on the opposite ends of the same wrench. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in wrench devices. Generally, when working on different projects that require wrenches, individuals may need to access SAE and metric sized wrenches. Further, the wrench device offers the individual the option of a single wrench that combines equivalent sizes of SAE and metric dimensions, reducing the number of wrenches required and the need to return to the toolbox for a different wrench. In addition, the weight of toolboxes and tool belts can be reduced when individuals need a variety of wrenches when working on different projects.

It is not uncommon to have an item, such as an engine, having both metric and SAE nuts and bolts. It is also not relatively apparent which measurement system the nut or bolt uses, metric or SAE, by simple visual inspection. Some metric sizes are very close to some SAE sizes, making the selection of the correct wrench more difficult. To pick the correct wrench, it is often necessary to try both SAE and metric wrenches to find the correct fit. The user must first approximate the size of the nut or bolt and then try wrenches of both systems. This can be a frustrating and time-consuming process, especially when working in tight confines.

Accordingly, there is a demand for an improved wrench device that features the equivalent SAE and metric sizes on the opposite ends of the same wrench. More particularly, there is a demand for a wrench device that reduces the need to return to a toolbox to retrieve a different sized wrench, saving the user time and effort.

Therefore, there exists a long-felt need in the art for a wrench device that provides users with a wrench or set of wrenches featuring the equivalent SAE and metric sizes on the opposite ends of the same wrench. There is also a long-felt need in the art for a wrench device that enables the individual the option of having a wrench with the equivalent sizes of SAE and metric on a single wrench. Further, there is a long-felt need in the art for a wrench device that reduces the need to return to a toolbox to retrieve a different size wrench, saving the individual considerable time, frustration, and effort. Moreover, there is a long-felt need in the art for a device that creates options when needing to carry different sized wrenches of SAE and metric, by reducing the number of wrenches required to complete the project. Further, there is a long-felt need in the art for a wrench device that enhances the individual's efficiency and convenience when working with the wrench devices. Finally, there is a long-felt need in the art for a wrench device that is available in numerous equivalent sizes.

The subject matter disclosed and claimed herein, in one embodiment thereof, comprises a wrench device. The device is a combination, handheld wrench or set of wrenches. The wrench device comprises a handle component with a head component secured to each end. The wrench device will have an SAE size on one head component and an equivalent metric size, on the other head component. Further, the wrench device is available in numerous equivalent sizes and configurations for all applications. Accordingly, the wrench device will benefit the user by having both SAE and metric sizes on a single wrench. This contributes to the user's timely completion of the project without having to return to the toolbox or job site to acquire the correct sized wrench.

In this manner, the wrench device of the present invention accomplishes all of the foregoing objectives and provides users with a wrench or set of wrenches with both SAE and metric sizes on opposite ends. The device reduces the need to carry different sized wrenches. The device is available in numerous equivalent sizes.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wrench device. The wrench device comprises a handle component with a head component secured to each end. The wrench device will have an SAE size on one head component and an equivalent metric size, on the other head component. Further, the wrench device is available in numerous equivalent sizes and configurations for all applications. Accordingly, the wrench device will benefit the user by having both SAE and metric sizes on a single wrench. This contributes to the user's timely completion of the project without having to return to the toolbox or job site to acquire the correct sized wrench.

In one embodiment, the wrench device enables the users the option of having a wrench or set of wrenches with the equivalent SAE and metric size on a single wrench. Further, it is not uncommon to have an item, such as an engine, having both metric and SAE nuts and bolts. Accordingly, the device creates options when needing to carry different sized wrenches of SAE and metric measurements, by reducing the number of wrenches required to complete the project. Thus, the wrench device enhances the user's efficiency and convenience when working.

In one embodiment, the wrench device discloses a specialized wrench with one end configured in a first measurement system, such as SAE, and the second opposing end configured in another measurement system, such as metric. Thus, the wrench device comprises the SAE measurement size on one end and the equivalent metric measurement size on the opposing end. Accordingly, it is possible to know approximately the correct size wrench needed but not the measurement system. Thus, having both measurement ends in a single tool, allows a user to pick a single wrench and have a high probability that one end of the wrench will correctly fit the nut or bolt. Further, the combination of a first measurement system and a second measurement system on each end of the wrench device, close in size to one another (i.e., equivalent measurements), greatly reduces time and effort in the removal and tightening of bolts and nuts. Additionally, the wrench device is a combination, hand-held wrench or a set of wrenches, all with the SAE measurement size on one end and the metric measurement size on the opposing end.

In one embodiment, the wrench device comprises a handle component with a head component secured at both ends. Typically, the handle component and opposing first and second head components are forged as one integral component but can be secured via any other suitable means as is known in the art. In one embodiment, the handle component and attached head components are of one-piece forged steel construction. Further, the handle component is an elongate handle shaped component for grasping by the hand and is of conventional configuration. Specifically, the handle component comprises a rectangular configuration with a top surface, a bottom surface, opposing front and back walls, and opposing side ends. The opposing side ends each secure a respective head component.

In one embodiment, the wrench device can be any suitable type of wrench as is known in the art, such as open end, box end, ratchet, and adjustable ratchet, etc., or any other suitable wrench type as is known in the art, as wrenches for turning fasteners such as nuts and bolts are available in a variety of configurations. Typically, each head component comprises an interior surface for accepting a nut or bolt and an exterior surface that is a rounded circular configuration, which is open or closed depending on the wrench type. Specifically, the open end wrenches have an open circular configuration (i.e., crescent-shaped) with an interior opening for accepting a nut or bolt, and the box end wrenches, ratchet wrenches, and adjustable ratchet wrenches have a closed circular configuration (i.e., doughnut-shaped) with a middle interior opening for accepting a nut or bolt.

Open end wrenches have fixed jaws which define a U-shaped interior opening for accepting the head of a fastener (i.e., nut or bolt). These wrenches are primarily designed for use with hexagonal or square fastener heads but also may be used with any fastener head having an equal number of faces. To turn the fastener, the wrench is placed over the fastener with the flat jaws of the wrench aligned with the flat surfaces on the head of the fastener, and force is exerted on the handle component. Specifically, the interior opening of the open end wrenches comprise an angled or squared interior which accepts a nut or bolt, allowing the bolt or nut to be tightened or loosened by turning, then removing the open end wrench from the bolt or nut, and replacing it, as it is tightened or loosened.

Box end wrenches have fixed jaws which define a circular shaped interior opening for accepting the head of a fastener (i.e., nut or bolt). These wrenches are primarily designed for use with polygonal fastener heads (i.e., hexagonal, square, polygonal, star, etc.) but also may be used with any fastener head having an equal number of faces. To turn the fastener, the wrench is placed over the fastener with the flat jaws of the wrench aligned with the flat surfaces on the head of the fastener, and force is exerted on the handle component. Specifically, the interior opening of the box end wrenches comprise an angled or polygonal interior which accepts a nut or bolt, allowing the bolt or nut to be tightened or loosened by turning, then removing the box end wrench from the bolt or nut, and replacing it, as it is tightened or loosened.

Ratchet and adjustable ratchet wrenches have rotatable jaws which define a circular shaped interior opening for accepting the head of a fastener (i.e., nut or bolt). These wrenches are primarily designed for use with polygonal fastener heads (i.e., hexagonal, square, polygonal, star, etc.) but also may be used with any fastener head having an equal number of faces. To turn the fastener, the wrench is placed over the fastener with the flat jaws of the wrench aligned with the flat surfaces on the head of the fastener, and force is exerted on the handle component. Specifically, the interior opening of both the ratchet wrenches and the adjustable ratchet wrenches comprise a rotatable ratchet interior surface, allowing a bolt or nut to be tightened or loosened without removing the ratchet/adjustable ratchet wrench from the bolt or nut. Further, at both opposing ends of the handle component of the adjustable ratchet wrench is a switch, such as a toggle switch, allowing for the ratchet direction to be changed, allowing for both tightening or loosening, as needed.

In one embodiment, a first head component on the first end of the handle component is sized and shaped to fit an SAE nut, whereas the second head component on the second end of the handle component is sized and shaped to fit a metric sized nut. However, the first end can be metric and the second end SAE or vice versa, depending on the needs and/or wants of a user. The metric end is the closest in size to the SAE end (i.e., the SAE end is approximately equivalent to the metric end). Sockets for SAE wrenches are generally sized every ⅛^{th} of an inch. Similarly, metric sockets are sized every millimeter. Accordingly, the metric end is the size that is closest in size to the SAE end, either slightly smaller or slightly bigger depending on the measurement. For example, the SAE size of ⅝^{th} of an inch is very close to 15 millimeters. Accordingly, the wrench device would have a first end comprising a ⅝^{th} inch SAE head component and an opposing second end of a 15 mm head component. However, this is simply a single example for illustrative purposes and the principle can be applied to any size. Further, the metric size may be slightly larger or slightly smaller, depending on the SAE size of the wrench head component. Thus, the wrench device allows the user to approximate the size of the nut or bolt to be removed and choose a wrench device which has a high likelihood of being the correct size, regardless of whether the nut or bolt is SAE or metric in measurement.

In yet another embodiment, the wrench device comprises a plurality of indicia.

In yet another embodiment, a method of providing users with options when needing to carry different sized wrenches is disclosed. The method includes the steps of providing a wrench device comprising a handle component and a head component on opposing sides of the handle component. The method also comprises providing an SAE size on one head component and a metric size on the other head component. Further, the method comprises choosing the correct sized wrench for the specific job. Finally, the method comprises reducing the number of wrenches needing to be carried in a toolbox.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the wrench device of the present invention showing numerous wrench designs in accordance with the disclosed architecture;

FIG. 2 illustrates a perspective view of one embodiment of the wrench device of the present invention showing the SAE sizes on the end of the device in accordance with the disclosed architecture;

FIG. 3 illustrates a perspective view of one embodiment of the wrench device of the present invention showing the SAE sizes of a plurality of wrench devices in accordance with the disclosed architecture;

FIG. 4 illustrates a perspective view of one embodiment of the wrench device of the present invention showing the equivalent metric size on the opposite side of the wrench device in accordance with the disclosed architecture;

FIG. 5 illustrates a perspective view of one embodiment of the wrench device of the present invention showing the reduced number of required wrench devices in the toolbelt in accordance with the disclosed architecture; and

FIG. 6 illustrates a flowchart showing the method of providing users with options when needing to carry different sized wrenches in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a wrench device that provides users with a wrench or set of wrenches featuring the equivalent SAE and metric sizes on the opposite ends of the same wrench. There is also a long-felt need in the art for a wrench device that enables the individual the option of having a wrench with the equivalent sizes of SAE and metric on a single wrench. Further, there is a long-felt need in the art for a wrench device that reduces the need to return to a toolbox to retrieve a different size wrench, saving the individual considerable time, frustration, and effort. Moreover, there is a long-felt need in the art for a device that creates options when needing to carry different sized wrenches of SAE and metric, by reducing the number of wrenches required to complete the project. Further, there is a long-felt need in the art for a wrench device that enhances the individual's efficiency and convenience when working with the wrench devices. Finally, there is a long-felt need in the art for a wrench device that is available in numerous equivalent sizes.

The present invention, in one exemplary embodiment, is a novel wrench device. The device is a combination, handheld wrench or set of wrenches. The wrench device comprises a handle component with a head component secured to each end. The wrench device will have an SAE size on one head component and an equivalent metric size, on the other head component. Further, the wrench device is available in numerous equivalent sizes and configurations for all applications. Accordingly, the wrench device will benefit the user by having both SAE and metric sizes on a single wrench. The present invention also includes a novel method of providing users with options when needing to carry different sized wrenches. The method includes the steps of providing a wrench device comprising a handle component and a head component on opposing sides of the handle component. The method also comprises providing an SAE size on one head component and a metric size on the other head component. Further, the method comprises choosing the correct sized wrench for the specific job. Finally, the method comprises reducing the number of wrenches needing to be carried in a toolbox.

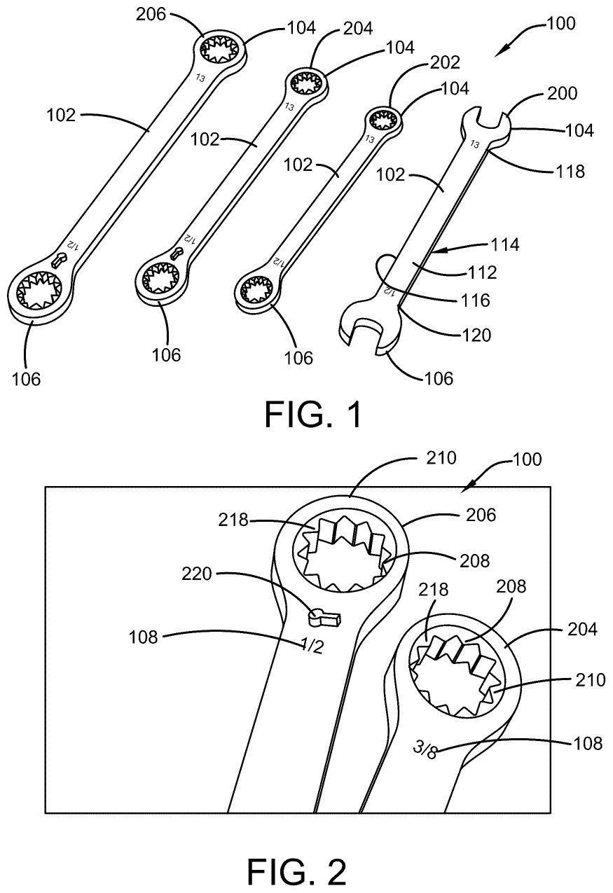

Referring initially to the drawings, FIG. 1 illustrates a perspective view of one embodiment of the wrench device 100 of the present invention. In the present embodiment, the wrench device 100 is an improved wrench device 100 that provides a user with a wrench or a set of wrenches featuring the equivalent SAE 108 and metric 110 sizes on the opposite ends of the same wrench. Specifically, the wrench device 100 comprises a handle component 102 with a head component 104, 106 secured to either end. The device 100 has an SAE size 108 on one end and the equivalent metric size 110, on the other end. Further, the wrench device 100 is available in numerous equivalent sizes and configurations for all applications. Accordingly, the wrench device 100 will benefit the user by having both SAE 108 and metric 110 sizes on a single wrench.

Generally, the wrench device 100 enables users the option of having a wrench or set of wrenches with the equivalent SAE 108 and metric 110 size on a single wrench. Further, it is not uncommon to have an item, such as an engine, having both metric and SAE nuts and bolts. Accordingly, the device 100 creates options when needing to carry different sized wrenches of SAE 108 and metric 110 measurements, by reducing the number of wrenches required to complete the project. Thus, the wrench device 100 enhances the user's efficiency and convenience when working.

Furthermore, the wrench device 100 discloses a specialized wrench with one end configured in a first measurement system, such as SAE 108, and the second opposing end configured in another measurement system, such as metric 110. Thus, the wrench device 100 comprises the SAE measurement size 108 on one end and the equivalent metric measurement size 110 on the opposing end. Accordingly, it is possible to know approximately the correct size wrench needed but not the measurement system. Thus, having both measurement ends in a single tool, allows a user to pick a single wrench and have a high probability that one end of the wrench will correctly fit the nut or bolt. Further, the combination of a first measurement system and a second measurement system on each end of the wrench device 100, close in size to one another (i.e., equivalent measurements), greatly reduces time and effort in the removal and tightening of bolts and nuts. Additionally, the wrench device 100 is a combination, hand-held wrench or a set of wrenches, all with the SAE measurement size 108 on one end and the metric measurement size 110 on the opposing end.

Additionally, the wrench device 100 comprises a handle component 102 with a head component 104, 106 secured at both ends. Typically, the handle component 104 and opposing first 104 and second 106 head components are forged as one integral component but can be secured via any other suitable means as is known in the art. In one embodiment, the handle component 102 and attached head components 104, 106 are of one-piece forged steel construction. Further, the handle component 102 is an elongate handle shaped component for grasping by the hand and is of conventional configuration. Specifically, the handle component 102 comprises a rectangular configuration with a top surface 112, a bottom surface 114, opposing front and back walls 116, and opposing side ends 118, 120. The opposing side ends 118, 120 each secure a respective head component 104, 106.

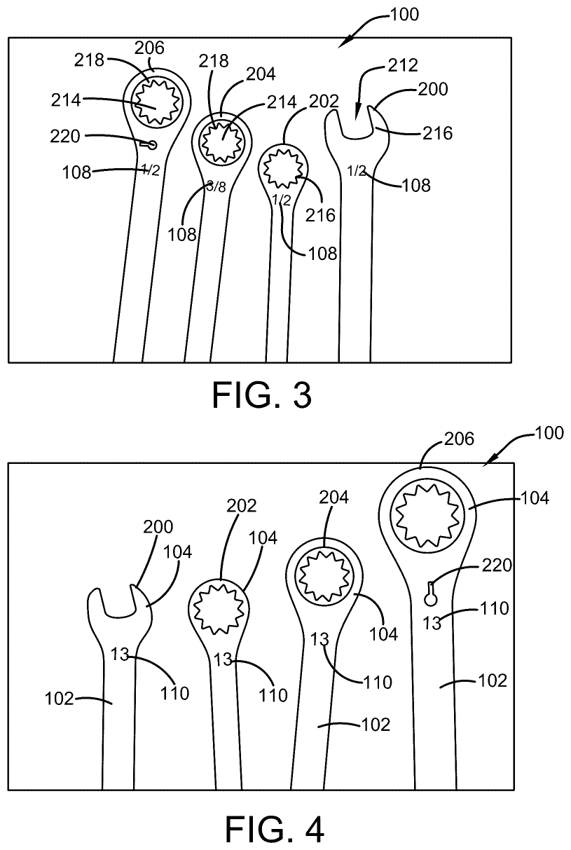

As shown in FIGS. 2-4, the wrench device 100 can be any suitable type of wrench as is known in the art, such as open end 200, box end 202, ratchet 204, and adjustable ratchet 206, etc., or any other suitable wrench type as is known in the art, as wrenches for turning fasteners such as nuts and bolts are available in a variety of configurations. Typically, each head component 104, 106 comprises an interior surface 208 for accepting a nut or bolt and an exterior surface 210 that is a rounded, circular configuration, which is open or closed depending on the wrench type. Specifically, the open end wrenches 200 have an open circular configuration (i.e., crescent-shaped) with an interior opening 212 for accepting a nut or bolt and the box end wrenches 202, ratchet wrenches 204, and adjustable ratchet wrenches 206 have a closed circular configuration (i.e., doughnut-shaped) with a middle interior opening 214 for accepting a nut or bolt.

Open end wrenches 200 have fixed jaws 216 which define a U-shaped interior opening 212 for accepting the head of a fastener (i.e., nut or bolt) (not shown). These wrenches 200 are primarily designed for use with hexagonal or square fastener heads but also may be used with any fastener head having an equal number of faces. To turn the fastener, the wrench 200 is placed over the fastener with the flat jaws 216 of the wrench 200 aligned with the flat surfaces on the head of the fastener, and force is exerted on the handle component 102. Specifically, the interior opening 212 of the open end wrenches 200 comprise an angled or squared interior which accepts a nut or bolt, allowing the bolt or nut to be tightened or loosened by turning, then removing the open end wrench 200 from the bolt or nut, and replacing it, as it is tightened or loosened.

Box end wrenches 202 have fixed jaws 216 which define a circular shaped interior opening 214 for accepting the head of a fastener (i.e., nut or bolt) (not shown). These wrenches 202 are primarily designed for use with polygonal fastener heads (i.e., hexagonal, square, polygonal, star, etc.) but also may be used with any fastener head having an equal number of faces. To turn the fastener, the wrench 202 is placed over the fastener with the flat jaws 216 of the wrench 202 aligned with the flat surfaces on the head of the fastener, and force is exerted on the handle component 102. Specifically, the interior opening 214 of the box end wrenches 202 comprise an angled or polygonal interior which accepts a nut or bolt, allowing the bolt or nut to be tightened or loosened by turning, then removing the box end wrench 202 from the bolt or nut, and replacing it, as it is tightened or loosened.

Ratchet 204 and adjustable ratchet 206 wrenches have rotatable jaws 218 which define a circular shaped interior opening 214 for accepting the head of a fastener (i.e., nut or bolt) (not shown). These wrenches 204, 206 are primarily designed for use with polygonal fastener heads (i.e., hexagonal, square, polygonal, star, etc.) but also may be used with any fastener head having an equal number of faces. To turn the fastener, the wrench 204, 206 is placed over the fastener with the flat jaws of the wrench 204, 206 aligned with the flat surfaces on the head of the fastener, and force is exerted on the handle component 102. Specifically, the interior opening 214 of both the ratchet wrenches 204 and the adjustable ratchet wrenches 206 comprise a rotatable ratchet interior surface, allowing a bolt or nut to be tightened or loosened without removing the ratchet 204/adjustable ratchet 206 wrench from the bolt or nut. Further, at both opposing ends 118, 120 of the handle component 102 of the adjustable ratchet wrench 206 is a switch 220, such as a toggle switch, allowing for the ratchet direction to be changed, allowing for both tightening or loosening, as needed.

Furthermore, a first head component 104 on the first end 118 of the handle component 102 is sized and shaped to fit an SAE 108 nut, whereas the second head component 106 on the second end 120 of the handle component 102 is sized and shaped to fit a metric sized 110 nut. However, the first end 118 can be metric 110 and the second end 120 SAE 108 or vice versa, depending on the needs and/or wants of a user. The metric end 110 is the closest in size to the SAE end 108 (i.e., the SAE end 108 is approximately equivalent to the metric end 110). Sockets for SAE 108 wrenches are generally sized every ⅛^{th} of an inch. Similarly, metric 110 sockets are sized every millimeter. Accordingly, the metric end 110 is the size that is closest in size to the SAE end 108, either slightly smaller or slightly bigger depending on the measurement. For example, the SAE size 108 of ⅝^{th} of an inch is very close to the metric size 110 of 15 millimeters. Accordingly, the wrench device 100 would have a first end 118 comprising a ⅝^{th} inch SAE head component and an opposing second end 120 of 15 mm head component. However, this is simply a single example for illustrative purposes and the principle can be applied to any size. Further, the metric size 110 may be slightly larger or slightly smaller, depending on the SAE size 108 of the wrench head component 104, 106. Thus, the wrench device 100 allows the user to approximate the size of the nut or bolt to be removed and choose a wrench device 100 which has a high likelihood of being the correct size, regardless of whether the nut or bolt is SAE 108 or metric 110 in measurement.

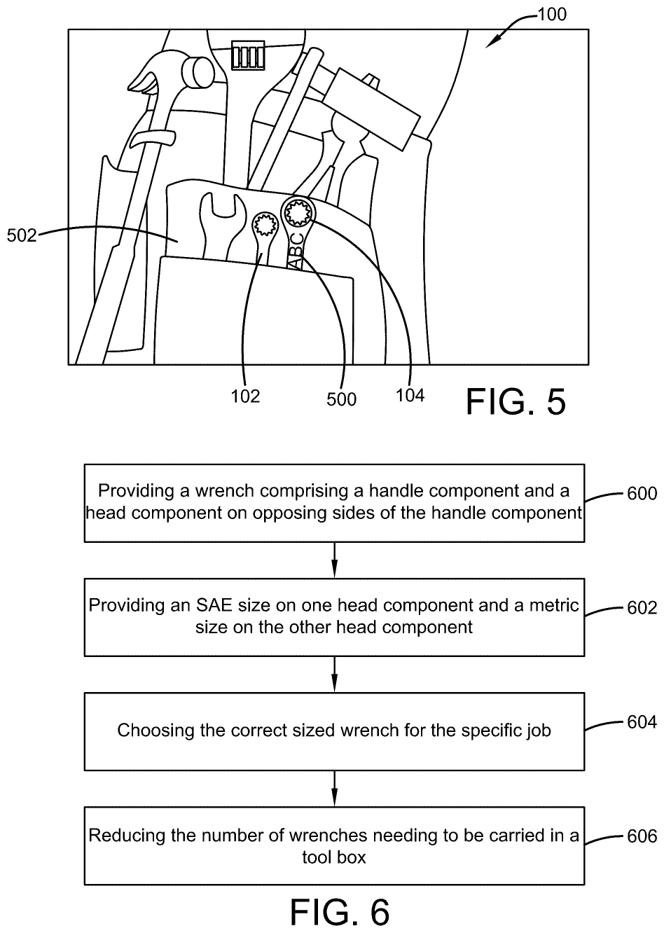

As shown in FIG. 5, the wrench device 100 is available in numerous equivalent sizes and configurations for all applications. Accordingly, the wrench device 100 combines equivalent SAE 108 and metric 110 sizes, reducing the number of wrenches needed in a tool belt 502. The wrench device 100 can be applied to a single wrench or a set of wrenches.

In yet another embodiment, the wrench device 100 comprises a plurality of indicia 500. The handle component 102 and the head components 104 of the device 100 may include advertising, a trademark, or other letters, designs, or characters, printed, painted, stamped, or integrated into the handle component 102 and the head components 104, or any other indicia 500 as is known in the art. Specifically, any suitable indicia 500 as is known in the art can be included, such as, but not limited to, patterns, logos, emblems, images, symbols, designs, letters, words, characters, animals, advertisements, brands, etc., that may or may not be wrench, measurement, or brand related.

FIG. 6 illustrates a flowchart of the method of providing users with options when needing to carry different sized wrenches. The method includes the steps of at 600, providing a wrench device comprising a handle component and a head component on opposing sides of the handle component. The method also comprises at 602, providing an SAE size on one head component and a metric size on the other head component. Further, the method comprises at 604, choosing the correct sized wrench for the specific job. Finally, the method comprises at 606, reducing the number of wrenches needing to be carried in a toolbox.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “wrench device” and “device” are interchangeable and refer to the wrench device 100 of the present invention.

Notwithstanding the foregoing, the wrench device 100 of the present invention can be of any suitable size and configuration as is known in the art without affecting the overall concept of the invention, provided that it accomplishes the above-stated objectives. One of ordinary skill in the art will appreciate that the wrench device 100 as shown in FIGS. 1-6 is for illustrative purposes only, and that many other sizes and shapes of the wrench device 100 are well within the scope of the present disclosure. Although the dimensions of the wrench device 100 are important design parameters for user convenience, the wrench device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wrench device that provides a user with a wrench having the equivalent SAE and metric sizes on opposite ends of the wrench, the wrench device comprising:
a handle component;
a first head component; and
a second head component;
wherein the first head component is secured to a first end of the handle component and the second head component is secured to a second end of the handle component;
wherein the first head component comprises an SAE measurement size;
wherein the second head component comprise a metric measurement size; and
further wherein the wrench device benefits users by having both the SAE measurement and metric measurement on a single wrench.

2. The wrench device of claim 1, wherein the wrench device is a single wrench with both the SAE measurement and the metric measurement.

3. The wrench device of claim 2 further comprising a set of wrenches, all with the SAE measurement size on the first end and the metric measurement size on the second end.

4. The wrench device of claim 3, wherein the handle component and first and second head components are an integral one-piece forged steel construction.

5. The wrench device of claim 4, wherein the handle component is an elongate handle shaped component for grasping by the hand.

6. The wrench device of claim 5, wherein the handle component comprises a rectangular configuration with a top surface, a bottom surface, opposing front and back walls, and opposing first and second ends.

7. The wrench device of claim 6, wherein the wrench device is at least one of an open end wrench, a box end wrench, a ratchet wrench, and an adjustable ratchet wrench.

8. The wrench device of claim 7, wherein the first and second head components each comprise an interior surface for accepting a nut or bolt and an exterior surface that is a rounded, circular configuration, which is open or closed depending on a wrench type.

9. The wrench device of claim 8, wherein the open end wrench comprises an open crescent-shaped configuration with an interior opening for accepting a nut or bolt.

10. The wrench device of claim 9, wherein the box end wrench, the ratchet wrench, and the adjustable ratchet wrench have a closed doughnut-shaped configuration with a middle interior opening for accepting a nut or bolt.

11. The wrench device of claim 10, wherein the open end wrench comprises a fixed jaw which defines a U-shaped interior opening for accepting a head of the nut or bolt.

12. The wrench device of claim 11, wherein the box end wrench comprises a fixed jaw which defines a circular shaped interior opening for accepting a head of a nut or bolt.

13. The wrench device of claim 12, wherein the ratchet wrench and the adjustable ratchet wrench both have rotatable jaws which define a circular shaped interior opening for accepting a head of a nut or bolt.

14. The wrench device of claim 13, wherein the first and the second ends of the handle component both comprise a switch which allows for ratchet direction to be changed, as needed.

15. A wrench device that provides a user with a wrench having the equivalent SAE and metric sizes on opposite ends of the wrench, the wrench device comprising:
a handle component comprising a rectangular configuration with a top surface, a bottom surface, opposing front and back walls, and opposing first and second ends;
a first head component comprising an interior surface for accepting a nut or bolt and an exterior surface that is a rounded, circular configuration, which is open or closed depending on a wrench type; and
a second head component comprising an interior surface for accepting a nut or bolt and an exterior surface that is a rounded, circular configuration, which is open or closed depending on a wrench type; and
wherein the first head component is secured to the opposing first end of the handle component and the second head component is secured to the opposing second end of the handle component to form an integral component;
wherein the first head component comprises an SAE measurement size;
wherein the second head component comprise a metric measurement size;
wherein the wrench device benefits users by having both the SAE measurement and metric measurement on a single wrench;
wherein the wrench device is a single wrench or a set of wrenches with both the SAE measurement and the metric measurement; and
further wherein the wrench device is at least one of an open end wrench, a box end wrench, a ratchet wrench, or an adjustable ratchet wrench.

16. The wrench device of claim 15, wherein the first head component on the opposing first end of the handle component is sized and shaped to fit a metric nut, whereas the second head component on the opposing second end of the handle component is sized and shaped to fit the SAE sized nut.

17. The wrench device of claim 16, wherein the SAE measurement and the metric measurement are sized to be approximately equivalent on the single wrench.

18. The wrench device of claim 15, wherein the wrench device is available in numerous equivalent sizes and configurations for all applications.

19. The wrench device of claim 15 further comprising a plurality of indicia.

20. A method of providing users with options when needing to carry different sized wrenches, the method comprising the following steps:
providing a wrench device comprising a handle component and a head component on opposing sides of the handle component;
providing an SAE size on one head component and a metric size on the other head component;
choosing the correct sized wrench for the specific job; and
reducing the number of wrenches needing to be carried in a toolbox.
